(19) United States
(12) Patent Application Publication
(10) Pub. No.: US 2010/0005520 A1
(43) Pub. Date: Jan. 7, 2010

(54) PERSONAL AREA SOCIAL NETWORKING

(75) Inventors: Kelly Abbot, San Diego, CA (US); Brian Jessup, San Diego, CA (US); Jon Gallagher, San Diego, CA (US); Craig Mautner, San Diego, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MeKey LLC, San Diego, CA (US)

(21) Appl. No.: 12/479,621

(22) Filed: Jun. 5, 2009

Related U.S. Application Data
(60) Provisional application No. 61/059,548, filed on Jun. 6, 2008.

(51) Int. Cl. G06F 15/16; G06F 21/00; G06Q 30/00; G06Q 50/00

(52) U.S. Cl. 726/6; 709/227; 709/205; 709/206; 705/14.53

(57) ABSTRACT

Techniques for managing the exchange of contact information are provided. Requests to establish connections on social networks and/or exchange contact information between users are held in escrow. The level of contact information and/or social network information shared between the users is configurable on a per user basis. Users may define levels of contact information and social network information to be shared with others based on the type of contact. Spam protection may be provided by requiring that both parties consent to a connection request before connections between the users are established.

### CROSS-REFERENCES TO RELATED APPLICATIONS

This application claims priority to U.S. Provisional Patent Application No. 61/059,548, filed Jun. 6, 2008.

### BACKGROUND

In a modern, Internet-connected world, social networking through clubs, churches, bars, nightclubs, and other venues has been supplemented by electronic social networking over the Internet. Social networking via the Internet is arguably one of the most successful applications of the Internet in the past several years. Wildly popular social networking sites, such as MYSPACE®, Facebook®, LinkedIn®, Yahoo! 360°®, MSN Spaces®, and Twitter® provide their subscribers with worldwide exposure to potential friends, dates, spouses, and business connections.

Social networking services typically rely on conventional computer browser-based connectivity over a network, such as the Internet. New relationships may be sought using a web browser operating on a network-connected computer system. Social network sites typically require that users select a unique user identifier for identification purposes on the social network site. A user may participate in multiple social networking sites, which may result in the user having to remember multiple different user ID and password combinations as it may not be possible for a user to obtain the same user ID on multiple social networking sites. As such, if a user wishes to establish connections with a new contact on more than one social networking site, the user may have to exchange multiple user identifiers with the new contact in order to establish connections on the different social networking sites.

In the world of business communications, people use business cards, address lists, notepads and/or other techniques for collecting contact information at networking events, such as seminars, trade shows, and conventions. Following up with contacts who have expressed interest in subsequent communication may require the information collected to be manually entered into a computer system for use in communicating with the contacts.

### SUMMARY

Techniques for managing the exchange of contact information are provided. Requests to establish connections on social networks and/or exchange contact information between users are held in escrow. The level of contact information and/or social network information shared between the users is configurable on a per user basis. Users may define levels of contact information and social network information to be shared with others based on the type of contact.

According to an embodiment, a method for managing the electronic exchange of contact information between users is provided. The method includes receiving a first connection request at a management server from a first user, the connection request including a first identifier associated with the first user and a second identifier associated with a second user with whom the first user would like to exchange contact information, and holding the first connection request in an electronic escrow wherein no connections are formed between the first user and the second user while the first connect request is held in the electronic escrow. The method also includes determining whether a second connection request from the second user has been received at the management server, the second connection request indicating that the second user would like to exchange contact information with the first user, the connection request including a third identifier associated with the first user and a fourth identifier associated with the second user; and executing the first connection request and the second connection request in response to determining that the second connection request has been received at the management server, wherein executing the first connection request includes providing contact information for the first user to the second user, and wherein executing the second connection request further comprises providing contact information for the second user to the first user.

In an another embodiment, a computer program embedded in a computer-readable medium is provided. The computer program product including instructions that, when executed by at least one computing device, cause the at least one computing device to: receive a first connection request at a management server from a first user, the connection request including a first identifier associated with the first user and a second identifier associated with a second user with whom the first user would like to exchange contact information and hold the first connection request in an electronic escrow wherein no connections are formed between the first user and the second user while the first connect request is held in the electronic escrow. The computer program product also includes instructions that, when executed, cause the at least one computing device to: determine whether a second connection request from the second user has been received at the management server, the second connection request indicating that the second user would like to exchange contact information with the first user, the connection request including a third identifier associated with the first user and a fourth identifier associated with the second user; and execute the first connection request and the second connection request in response to determining that the second connection request has been received at the management server, wherein executing the first connection request includes providing contact information for the first user to the second user, and wherein executing the second connection request further comprises providing contact information for the second user to the first user.

In yet another embodiment, a system for managing the electronic exchange of contact information between users is provided. The system includes a processor and a memory device. The memory device includes instructions that, when executed by the processor, cause the processor to: receive a first connection request at a management server from a first user, the connection request including a first identifier associated with the first user and a second identifier associated with a second user with whom the first user would like to exchange contact information and hold the first connection request in an electronic escrow wherein no connections are formed between the first user and the second user while the first connection request is held in the electronic escrow. The memory device includes instructions that, when executed by the processor, cause the processor to: determine whether a second connection request from the second user has been received at the management server, the second connection request indicating that the second user would like to exchange contact information with the first user, the connection request including a third identifier associated with the first user and a fourth identifier associated with the second user; and execute the first connection request and the second connection request in response to determining that the second connection request has been received at the management server, wherein executing the first connection request includes providing contact information for the first user to the second user, and wherein executing the second connection request further comprises providing contact information for the second user to the first user.

### BRIEF DESCRIPTION OF THE DRAWINGS

FIG. 1 is a high level block diagram of a personal area networking system according to an embodiment of the disclosure.

FIG. 2 is a high level block diagram of a server that may be used to implement a personal area networking system.

FIG. 3 is a flow diagram of a process for enrolling a user with a personal area networking system.

FIG. 4 is a flow diagram of a process for associating a mobile device with a user profile.

FIG. 5 is a flow diagram of a process for exchanging contact information between users.

FIG. 6 is a flow diagram of a process for connecting a user with a user group.

FIG. 7 is a flow diagram of a process for processing pending connections.

FIG. 8 is a flow diagram of another process for exchanging contact information between users.

### DETAILED DESCRIPTION

Techniques for managing the exchange of contact information and social network information are provided. Establishment of connections on social networks is automated by identifying social networks that users have in common, determining their desire to make connections on these networks and generating connection requests to establish connections between the users on those social networks. A user may establish a profile having a unique identifier that may be shared with other users in order to establish connections with those other users. The unique identifier may be associated with contact information such as telephone numbers, email addresses, physical mailing addresses, and/or social network contact information, and the user may share this unique identifier with other users in order to automatically exchange contact information and/or establish connections on social networks in which the users are members. Users may control what contact information and/or social network information is shared with other users, and spam protection may be provided by requiring that both parties consent to a connection request before connections between the users are established.

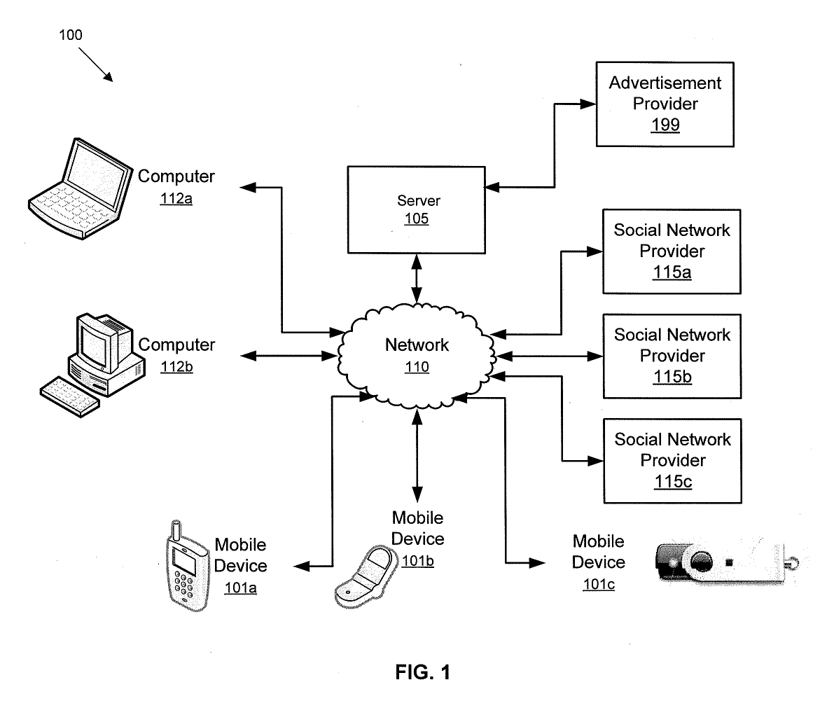

FIG. 1 is a high level block diagram of a personal area networking system 100. System 100 includes a management server 105 configured to communicate via a network 110 with a mobile devices 101a-101c and a plurality of computer systems 112a-112b. Management server 105 is also configured to communicate with a plurality of social network providers 115a-115c.

Computer systems 112a-112b are connected to network 110 enabling two-way communications with management server 105. Computer systems 112a-112b can include any appropriate device operable to send and receive requests, messages, or information over network 110 and convey information back to a user of the device. Examples of such computer systems include personal computers, laptop computers, set-top boxes, personal data assistants, and the like.

Mobile devices 101a-101b can include any appropriate device operable to send and receive requests, messages, or information over network 110 and convey information back to a user of the device. Mobile devices may include the ability to send and receive text messages, such as Short Message Service (SMS) message and/or email messages. Examples of such mobile devices include cell phones, smart phones, handheld computers or laptops, and handheld messaging devices.

Mobile device 101c illustrates an example of a portable electronic device for exchanging contact information. The portable electronic device is configured to store a unique identifier that may be associated with a user profile in the personal area networking system 100. In an embodiment, the portable electronic device is configured to wirelessly exchange contact identifiers with another portable electronic device proximate to the portable electronic device. In an embodiment, a user having such an electronic device may exchange contact identifiers with another user also having a portable electronic device by holding the portable electronic devices proximate to one another. In another embodiment, a portable the portable electronic devices may include an “exchange contact identifiers” button that, when pressed, activates a transmitter in the portable electronic device to transmit the contact identifier associated with the device, which may be received by proximate devices configured to receive the contact information. The portable electronic device stores the contact information in a memory, such as a flash memory, until the contact information can be uploaded to server 105 of personal area networking system 100. In an embodiment, a user may connect the portable electronic device to computer system 112 and upload connection information to server 105 of personal area networking system 100 for processing. In an embodiment, the portable electronic device may comprise a USB-based device, such as a USB flash drive. Devices that include other types of physical and/or wireless interfaces may also be used.

According to some embodiments, the portable electronic device may include a fixed unique identifier. According to other embodiments, the portable electronic device may be reconfigurable to store a new unique identifier. For example, the portable electronic device may be connected to computer system 112 to access server 105 to receive a new unique identifier from server 105. According to other embodiments, the portable electronic device may be configured to generate a new unique identifier and to store the new unique identifier in a persistent memory. According to some embodiments, portable electronic device may be configured to generate a unique identifier that server 105 may recognize. For example, the portable electronic device may use a RSA key that has a rotating code that server 105 has associated with the device. Server 105 may use the generated code to identify the portable electronic device via a timestamp and/or other information. The generated code may be provided to another user's device, which in turn provides the generated code to server 105 to establish connections between the user whose device generated the code and the user whose device received the code.

Social network providers 115a-115c comprise social network systems, such as MYSPACE®, Facebook®, LinkedIn®, Yahoo! 360°®, MSN Spaces®, Twitter®, etc. Server 105 communicates with social network providers 115a-115c via network 110. Social network providers 115a-115c may comprise one or more server systems.

Management server 105 provides a user interface that enables a user to create user profiles that include contact information for the user and to exchange contact information with other users. Management server 105 is also configured to receive connection requests from users who have not yet created a user profile and to hold the connection requests until the users create a profile. The contact information may include telephone numbers, email addresses, and/or user identifiers associated with the user on social networks provided social network providers 115a-115c. As described above, a user profile is associated with a unique user identifier that a user may provide to another user, i.e. a new contact, with whom the user wishes to exchange contact information. The unique user identifier provided to the contact by the user enables the user to protect his or her contact information and/or social networking information. The user may specify which contact information and/or social networking information may be shared with the contact, and the management server 105 will automatically exchange the specified contact information and/or establish connections on social networks that the user has authorized and the user and the contact have in common.

Management server 105 may prevent unauthorized dissemination of a user's contact information by placing requests to exchange information into escrow. In some embodiments, requests from both parties who wish to exchange information may be received and authenticated before the system exchanges contact information and/or social networking information between the parties. Placing requests into escrow also thwarts spammers from deluging a user with connection requests, because a user may configure his or her user profile to require that a reciprocal request be received before a connection request may be processed. A connection request preferably will not be processed unless a reciprocal request is received from the contact to whom the first connection request is directed. However, according to some embodiments, a user may configure his or her profile such that a connection request may be executed by the management server without receiving a reciprocal connection request, but management server 105 may send a confirmation request to the user before establishing the connections to provide the user with the opportunity to accept or reject the connection request. A user may configure his or her user profile to instruct server 105 to send a confirmation request before making some or all connections. For example, a user may elect to automatically process connection requests where the user has submitted the connection request to server 105 and has included his or her password in the connection request. The user may also configure his or her user profile to require that a confirmation request be sent to the user before a third party connection request may be executed. Third party connection requests are described in greater detail below.

According to some embodiments, a connection may be held in escrow if one or both parties have not completed their profile. In order for a user's profile to be complete, user may only need to provide a minimal amount of contact information and/or account information. For example, management server 105 may determine that a profile has been completed when the user provides an email address, selects a password, and provides a telephone number for a mobile device, such as a mobile phone or a unique identifier associated with a portable electronic device. Management server 105 may send a reminder or reminders to the user having the incomplete profile, and if the user or users complete their profiles, the connection request may be released from the electronic escrow.

Management server 105 may also be configured to process third party connection requests and group connection requests. Third party connection requests originate from a third party who submits a request to connect two or more other users. Third party connection requests may be used in a number of social and/or business situations to refer or introduce users. Group connection requests enable a user to establish connections with a group of people by submitting a single connection request. Server 105 processes group connection requests and may create a connection between the user that submitted the request and the other users that have already joined the group. Server 105 may also then create connections between the user and other users who subsequently join the group.

Management server 105 may provide an interface, such as a web page, that enables users to manage their contact information. The contact interface may also enable the user to define contact profile levels. The user may define one or more contact profile levels and may select a set or subset of the user's contact information and/or social network information to be associated with a particular contact profile level. The user may then associate a contact profile level with one or more contacts to indicate that these contacts should have access to the contact information and/or social networks associated with the contact profile level. For example, a user may define a contact profile level called “business” for business related contacts and may associate business contact related information, such as a work telephone number and work email address with the business contact profile level. If the user associates a contact with the business contact profile level, the business contact related information associated with the business contact profile level may be shared with the contact.

The contact interface may provide a listing of the contacts with whom the user is connected, including which information the user has agreed to share with the contact and which information the contacts have agreed to share with the user. For example, the contact interface may provide icons or other visual indicators, such as a checkbox, that represent contact information and/or social networking sites to identify which information has been shared between the user and the contacts. For example, in one embodiment, an icon with a check mark or a checkbox that is checked may represent contact information or social networking information that has been shared, while a icon with an “X” or an unchecked checkbox may represent contact information or social networking information that has not been shared. The information displayed for each contact may be determined based on each contact's user profile and/or a contact profile level that the contact selected when making the connection to the other user. For example, some users may elect not to share social networking information for some social networking sites with some users. The contact interface may enable the user to view and/or modify contact information at any time after the contact has been created. In some embodiments, server 105 may also accept text messages and/or email messages via the contact interface that include commands to update the contact information. For example, a user may send a text message to server 105 that includes an “updates shared information” command that identifies contact information and/or social networking information to be added or removed from the set of contact information and/or social networking information shared with a contact.

According to an embodiment, a user may update an existing contact profile level to add or remove contact information and/or social networking information associated with the contact profile level. In some embodiments, the contact profile interface may include an option that enables the user to propagate changes to a contact profile level to all contacts that are associated with that contact profile level. For example, if a user has a new business mobile phone number and has subscribed to a new social network for business networking, the user may update a “business contact” contact profile level associated with the user's profile to include the new mobile phone number and social networking information for the new social network. After adding the new contact information and social networking information to the “business” contact profile level, the user may be prompted by server 105 to determine whether the user would like to propagate the new information to all existing contact associated with the “business” contact profile level. If the user responds affirmatively, server 105 updates the all of the user's “business” contacts with the new information. If the user elects not to update all existing “business” contacts, the newly added information will be shared with any subsequently added business contacts, but not with existing business contacts. A user may also opt to manually update the information shared with individual contacts using the contact interface.

The contact interface may also provide the user with the ability to share additional information with a contact or establish connections with the contact on additional social networks. For example, if the user is already connected with a contact via Facebook® but not via LinkedIn®, the user may submit a connection request to connect to the contact on LinkedIn®. Server 105 will process the connection request to determine whether the contact's user profile would permit the connection to be formed automatically, or whether a confirmation request would be need to be sent to the contact to enable the contact to confirm the connection. In an embodiment, the contact interface may display social network contact information for contacts even if the user is not currently a member of a social networking site to which a contact belongs. If the user becomes a member of the social networking site, the user may submit a connection request to server 105 from the contact interface to establish a connection with the contact on the social networking site.

The user may also opt to share additional information with a contact. For example, if the user has shared his or her email address with a contact but not his or her mobile number, the user may submit a request to server 105 to provide the contact information to the contact. When the contact logs into the system, the contact's contact information page would display the user's mobile number and email address (and any other contact information that the user opted to share with the contact).

Network 110 may comprise a public network, such as the Internet. Computers 112a-b, mobile devices 101a-101c, and social network providers 115a-c may connect to network 110 through one or more intermediary networks. Network 110 may provide a wired and/or wireless communications between management server 105 and computer systems 112a-b, mobile devices 101a-c, and social network providers 115a-c. The network can include any appropriate network, including an intranet, the Internet, a cellular network, a local area network, or any other such network or combination thereof.

Server 105 may send requests for and receive advertisement content from advertisement provider 199. Advertisement provider may be a third-party electronic advertisement provider that provides advertisements for display on web page, mobile phones, and/or other electronic devices. In some embodiments, advertisement provider 199 may be operated by the operator of management server 105 and may in some embodiments be a service incorporated into server 105.

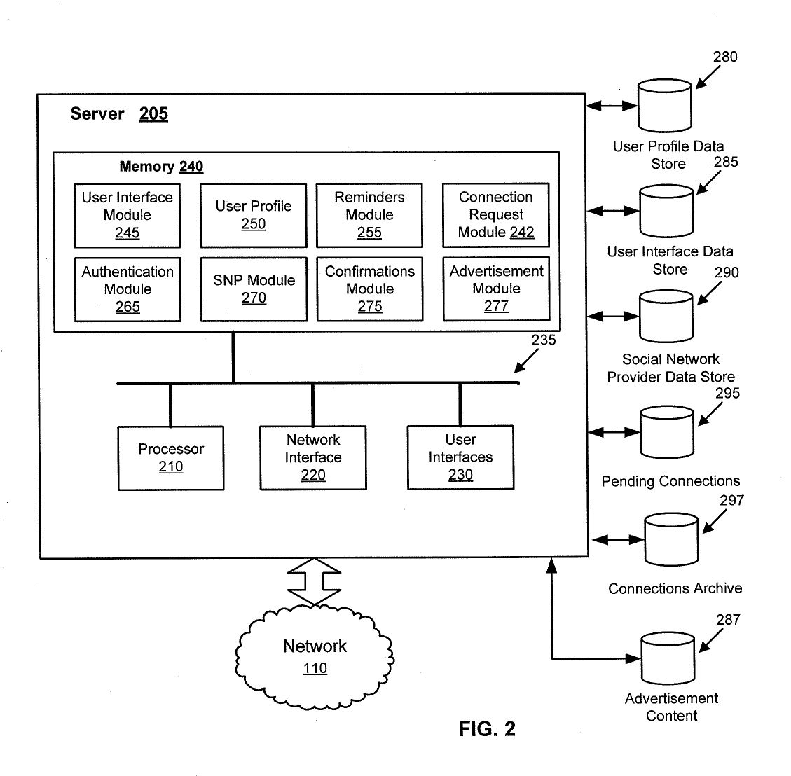

FIG. 2 is a high level block diagram of a server 205, connected to network 110 and data stores 280, 285, 290, and 295, that may be used to implement a management server 105. Server 205 includes a processor 210, network interface 220, user interfaces 230, bus subsystem 235, and memory 240. Bus subsystem 235 transfers data between the various components of server 205. Although bus subsystem 235 is depicted as a single bus, alternative embodiments of the bus subsystem may utilize multiple buses. Network interface 220 provides a communication interface between server 205 and network 110, and enables server 205 to send data to and receive data from computer systems 112a-b, mobile devices 101a-c, and social network providers 115a-c.

User interfaces 230 may include various input and output devices that enable a user to provide input to server 205 and receive data output from server 205. For example, user interface 230 may include input devices, such as a keyboard, pointing devices such as a mouse, trackball, touchpad, or graphics tablet, a scanner, a barcode scanner, a touch screen incorporated into the display, audio input devices such as voice recognition systems, microphones, and other types of input devices. In general, use of the term “input device” is includes all possible types of devices and mechanisms for inputting information to server 205. User interfaces 230 may include various output devices, such as a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from server 205.

Memory 240 may include various types of memories including persistent memories and volatile memories. For example, memory 240 may include persistent memories, such as read only memory (ROM) a hard disk drive, a floppy disk drive along with associated removable media, a Compact Disk Read Only Memory (CD-ROM) drive, an optical drive, removable media cartridges, and other like storage media. Memory 240 may include volatile memories, such as random access memory (RAM).

Server 205 reads and/or writes data to user profile data store 280, user interface data store 285, social network provider data store 290, pending connections data store 295, and connections archive data store 297. Data stores 280, 285, 290, 295, and 297 may, in some embodiments, be implemented on server 205, while in other embodiments, data stores 280, 285, 290, 295, and 297 may be implemented on a different server.

Memory 240 includes a number of modules implemented as computer-readable code, that when executed by processor 210, cause processor 210 to perform various functions. User interface module 245 generates a user interface for interacting with the personal area networking system, such as a web page, an application, or text message. User interface module 245 may access user interface data store 285 to access user interface components such as text, images, video, or other audiovisual components to be used to generate a user interface. User interface module 245 may also provide an interface for receiving connection requests, reminder information, and/or other information from users via network 110. For example, user interface module 245 may receive connection requests and/or other information submitted by users via a mobile device or computer system connected to network 110 either directly or through an intermediary network. For example, a user may submit connection requests via text or multimedia messages via a mobile phone provider's network, and the data is then transmitted to server 205 via network 110.

Connection request module 242 receives and processes connection requests from users. In an embodiment, connection request module 242 may receive connection requests submitted by users via user interface module 245. Connection request module 242 may interface with authentication module 265 to authenticate users. Connection request module 242 may store pending connection requests in pending connections data store 295. Connection request module 242 may also interface with user profile module 250 to access user profile information and with reminders module 255 for sending reminders and for confirmation module 275 for sending conformations to users. Connection request module 270 may also interface with SNP module 270 for accessing social network information required for sending connection requests on the various social networks. In some embodiments, a user may include one or more direct connection commands in a connection request, a direct connection command identifies a social network on which the user submitting the request would like to establish a connection with a new contact. A user may submit a connection request that includes a direct connection command that instructs the server 105 to provide connection information for Facebook® to a new contact and/or sent a request to the Facebook® network to connect the user with the new contact on Facebook®. For example, a user may send a connection request to server 105 “connect Brian Facebook MySpace” to have exchange social network information with user Brian. Server 105 may generate connection requests to the Facebook and MySpace social networking sites if the user and Brian are both members of these sites. In some embodiments, the user may include one or more contact information commands in a connection request that identifies specific contact information to share with a new contact. The connection request may include a contact information command to send the user's email address and/or other information to a new contact. For example, a user may send a connection request “connect Brian personal email” to have the user's personal email sent to user Brian. In some embodiments, a user may submit a connection request that includes a combination of one or more direct connection commands and one or more contact information commands.

User profile module 250 provides functionality for creating and accessing user profile information. A user profile includes contact information and/or social networking information for a user. User profile module 250 may provide a list of potential contact information and/or social networking information that may be shared with a contact or may provide predetermined groups of information that may be shared. In an embodiment, a user profile may include various contact profiles that define the level of contact information to be shared with other users associated with these contact profiles. For example, a user may wish to share only a business telephone number, email address, and website address with business contacts, may wish to share only personal mobile phone number and email address with friends and family, and may wish to share only an email address with new acquaintances. User profile module 250 may write user profile data to and access user profile data from user profile data store 280. In response to user requests to create a new user profile or manage an existing user profile, user profile module 250 may request that user interface module 245 generate an appropriate interface for a device, such as mobile device 101a-101c or computer systems 112a-112b that enables the user to create or modify a new user profile. For example, a user accessing the server from a laptop computer may be provided a web page for creating and/or modifying the user's profile information, while a user accessing server 205 via a mobile device may be provided with an interface formatted appropriately for a mobile device. For example, the content may be formatted for a smaller screen size found on many mobile devices (e.g. less or smaller graphics or all text) or the content may be sent in a form of a text message or email to the device.

A user profile may also have one or more associated mobile devices. For example, a user may have multiple mobile phones, a work mobile phone and a personal mobile phone, from which the user may contact the server to initiate an exchange of contact information. The user may add each device to the user's profile so that sever 205 will associate messages received from the mobile device as being associated with the user. In an embodiment, the user may provide a telephone number associated with the mobile device in order to associate the mobile device with the user's profile, and server 205 will associate messages received from the mobile device with the user based on the phone number of the device from which the message was received.

Authentication module 265 uses user profile information stored in user profile data store 280 to authenticate users from which messages have been received. For example, server 205 may receive a message from a user requesting that contact information be exchanged with another user, i.e., a contact. Authentication module 265 determines, based on the source of the message, whether the user sending the message has a user profile, and based on the user identifier provided in the message whether the contact also has a profile. For example, a user may send a text message to a predetermined number associated with the personal area networking system that includes a connection command and a unique identifier of a contact or group of contacts with whom the user wishes to establish a connection. The connection command may include a contact profile level to assign to the contact or group of contacts and/or specify a particular type of connection to establish with the new contact or group of contacts. For example, the connection command may indicate that the new contact or group of contacts is/are business contacts and that only business contact related information, such as a work telephone number and work email address, should be shared with the contact or group of contacts. In an embodiment, the connection command may instruct the server to establish a connection via a specific social network provider, such as Facebook® or LinkedIn®. The unique identifier of the new contact may be, e.g., a user ID assigned to the user by the personal area networking system (if the contact already has a user profile with the personal area networking system), a telephone number or other unique ID associated with the new contact's mobile device, etc.

Authentication module 250 may require that the user enter a personal identification number (PIN) in conjunction with the connection command, and the authentication module compares the PIN provided to the PIN associated with the user's profile. In an embodiment, the PIN may comprise a numerical text string, or in other embodiments, may comprise an alphanumeric text string. If the PIN provided with the connection command does not match the PIN on the user's profile, the personal area networking system will not execute the connection command. The PIN provides an additional level of security to the system. If the user has lost his or her mobile device, unauthorized people would be inhibited from accessing the user's account in order to establish connections with the user and gain access to their personal contact information.

In an embodiment, authentication module 250 may also receive commands to add a device to a user's profile. For example, the user may send an “add device” command in a text message to the personal area networking system from a new mobile device where the command string includes the user ID and password of the user. The authentication module 250 compares the user ID and password to that of user's profile and adds the new device to the user profile. In another embodiment, the user may send an “add device” command in a text message to the personal area networking system and server 205 will send a return text message to the user that includes an access code. The user may then log onto server 105 to access their user profile and add the access code to the user profile in order to associate the device with the user profile. In another embodiment, the user may also log into the personal area networking system to access the user profile information from a computer system 112 and update the user profile data to include the new device's telephone number or other unique identifier.

Social network providers (SNP) module 270 interfaces with the various social network providers, such as Facebook®, MySpace®, Twitter®, Yahoo! 360°®, MSN Spaces®, LinkedIn®, and/or other social network providers. The social network providers may have very different protocols and/or interfaces for establishing connections to users of their social networks. For example, Facebook® and MySpace® provide different application programming interfaces (APIs) for creating connection requests. SNP module 270 generates connection requests of the appropriate format for each social network provider in response to requests from users to form new connections. In some embodiments, authentication module 250 may communicate connection requests to SNP module directly after authenticating the source of the request. In some embodiments, authentication module 250 may store connection requests in pending connections data store 295, and SNP module 270 may access pending connections data store 295 to retrieve pending connection request information and generate connection requests to the appropriate social network providers. The implementation of the APIs is controlled by the social networking providers, and each social networking provider may provide different APIs and different methods for processing connection requests. In some social networking systems, the API may require that the user receiving the connection request perform additional steps to complete the connection, while in other social networking systems the API may allow for direct connections to be made between users.

After connection requests have been processed connections request may be removed from pending connections data store 295 to connections archive data store 297. Connection requests may also be removed from pending connections data store 295 and stored in connections archive data store 297 if a connection request times out or in response to a confirmation request where a user indicates that he or she does not wish to exchange contact information and/or social networking information with another user. Confirmation requests are described in detail below. In some embodiments, personal area networking system 100 may provide an interface, such as a web page, that enables users to view archived connection requests and to request that the connection requests be executed. For example, user 1 may lose a connection to user 2 in a social network and wish to reconnect to user 2. If the users were originally connected via connection requests through personal area networking system 100, user 1 may select the archived connection request from the archive and request that the connection request be executed by personal area networking system 100.

Reminders module 255 may generate reminder information to users regarding pending connection requests and may also generate reminders for new users to complete a user profile. Reminders may provide a user with information about a new contact included in a connection request. Reminders may include information about the new contact, notes about how and when the user met the new contact, audiovisual content, such as text, pictures, audio, video, or other media, GPS coordinates captured by the user's mobile device at the time that the connection request was sent to the server, and/or other information. For example, a reminder may be a simple textual note that identifies the new contact and how the user met the contact: “Met KGA at restaurant, talked about baseball, made personal contact.” Reminder information may be entered as part of a connection command text string sent to the personal area networking system server 105. Reminders may also include information from the new contact's user profile that the new contact has indicated may be shared with other users before a connection is established. For example, a user may select a subset of his or her profile information, such as the user's name, hometown, profession, photo, and/or other information that may help someone else remember the user.

In an embodiment, a multimedia messaging service (MMS) message may be sent as a reminder. An MMS message may include multimedia content, such as text, rich text, images, audio, and/or video content. In another embodiment, a reminder message may be sent to a user via email and may include multimedia content. In yet another embodiment, a reminder message may be sent as a text-only message, e.g. via SMS, to a user's mobile handset. Reminders module 255 may be configured to send a reminder to the user regarding a pending connection request after a specified elapsed time after the user sends the connection command to the server. In an embodiment, a user may also access reminders through a browser interface of a computer system 112. For example, in an embodiment, reminder information may be displayed to users when upon logging into the personal area networking system 100. In some embodiments, personal area networking system 100 may provide a reminders web page that a user may access to view any reminders associated with the user. In some embodiments, reminder information about potential contacts may be displayed on the contact interface provided by server 105. The reminder interface may display the text and/or other reminder content to the user. The reminder content displayed on the contact interface may serve as a reminder to that the user regarding why they may wish to connect with the potential new contact or other details regarding the connection. In some embodiments, the contact interface may include an interface for a user to submit a connection request to a potential new contact.

Reminders module 255 may also send reminder messages, e.g. text message, email, etc. to a new user for whom a temporary user profile was created in response to a connection request. In order for connection requests to be executed, the users included in the connection request (sender and receiver) should have completed their user profiles. Reminders module may 255 may also be configured to send reminders to users to perform other actions in the personal area networking system 100.

Confirmations module 275 sends a confirmation request to a user to confirm that the user wishes to create the connections specified in a connection command before executing the connection command. This feature provides the user with the opportunity to confirm that the user wishes to provide contact information with the new contact before any personal information is shared with the new contact and before any connection requests are made to social network providers 115a-115c. A user may opt to not receive confirmations from the system by opting out of receiving confirmations in the user's profile data. As described above, a user may configure his or her user profile to instruct server 105 to send a confirmation request before making some or all connections. For example, a user may have different requirements for connection requests submitted by the user and connection requests submitted by a third party.

In some embodiments, a confirmation may include reminder information such as text and/or other content that was submitted to server 105. The reminder information may include may include information about a potential new contact, notes about how and when the user met the new contact, audiovisual content, such as text, pictures, audio, video, or other media, GPS coordinates captured by the user's mobile device at the time that the connection request was sent to the server, and/or other information. The reminder information may be included in the confirmation request in order refresh the user's memory about a potential new contact before the user commits to exchanging contact information and/or social networking information with the potential new contact.

Advertisement module 277 may be used to generate advertisement content in the form of electronic advertisement content to be displayed to the user. The electronic advertisement content may include text, images, video, audio, and/or other audiovisual content. The advertisement content may be stored in advertisement content data store 287. According to some embodiments, the advertisement content may be provided by advertisement provider 199.

In some embodiments, advertisement module 277 may interface with reminders module 255 and confirmations module 275 to provide context sensitive advertising that is related to reminder content and/or confirmation content. For example, reminder module 255 may generate a reminder “met Jay—talked baseball” based on reminder information provided by a user. Reminder module 255 may provide reminder information to advertisement module 277, which parses the reminder information and uses the that information to identify related advertisement content from advertisement content data store 287 and/or to request related content from advertisement provider 199. In some embodiments, advertisement module 277 may sent electronic advertisements to users at the time that a reminder, confirmation, or other information is sent to a user. For example, server 105 may identify the parse the reminder info “met Jay—talked baseball” and send the user that submitted the reminder and/or Jay an electronic advertisement related to baseball, e.g. an advertisement for the San Diego Padres®. Electronic advertisement module 277 may also interface with user interface module 245 to provide electronic advertisements for display on web page or other user interface generated by user interface module 245. For example, user interface module 245 may request one or more electronic advertisements from electronic advertisement module 277 to be displayed on the contact interface page. The advertisements selected may be selected based on reminder information content associated with the user and/or other content displayed by in the web page.

Advertisement module 277 may also store advertisement preference information for users in user profile data store 280 for use in selecting electronic advertisements that are more likely to be of interest to the users. For example, advertisement module 277 may parse connection requests, reminder information, user profile information, and/or confirmation information to identify categories of advertisements that may be of interest to a user. Advertisements module 277 may also select advertisements based on a user's demographic information such as age, income, gender, location, and/or other demographic information about the user. Some demographic information may be obtained from the user profile information provided by the user, while other information, such as location may be obtained through other techniques. For example, a location of a user may be determined based on an Internet Protocol (IP) address of a computer system or mobile device of the user, may be obtain location information from a Global Positioning System (GPS) receiver included in the computer system or mobile device of the user, may be determined using information from mobile phone network provider providing connectivity to a user's mobile device, and/or may be obtained through other techniques. Advertisement module 277 may also select advertisements based on a purchase history of the user and/or based on other types of advertisements that have been selected or clicked on by the user in the past. Other factors, such as the time of day, the date, and/or current weather conditions may also be considered when selecting advertisements for display to a user. For example, an advertisement for a restaurant service hot soup and sandwiches may selected for display to a user instead of an advertisement for an ice cream shop during the winter.

Advertisement module 277 may also send advertisements to users with a response to a connection request. For example, a user may send in a connection request and server 105 may request an electronic advertisement related to the location and/or other user preferences determined by advertisement module 277. For example, if user submits a connection request a 8:00 am from a location that is on the same block as a coffee shop, advertisement module 277 may select an advertisement for the coffee shop based on the time of day and the location of the user.

While connection request module 242, user interface module 245, user profile module 250, reminders module 255, authentication module 265, SNP module 270, confirmations module 275, and advertisement module 277 are described as being implemented in software in FIG. 2, these modules may be implemented in hardware, software, or a combination thereof in other embodiments.

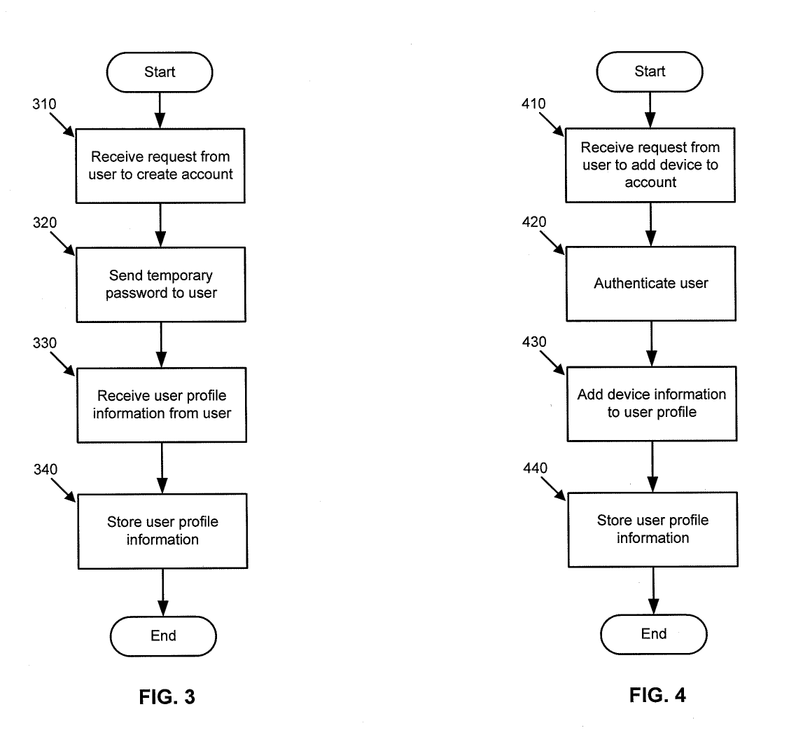

FIG. 3 is a flow diagram of a process 300 for enrolling a user with a personal area networking system. A user sends a request to create a new user profile to server 105 (stage 310). In an embodiment, a user may send a text message “join” to a predetermined number associated with the personal area networking system. Authentication module 250 may compare a telephone number or other unique identifier associated with the mobile device from which the request originates to a number associated with existing user profiles in user profile data store 280 to determine whether the mobile device is already associated with a user profile in the system. According to some embodiments, if there is a user profile already associated with the mobile device in the personal area networking system 100, server 105 may transmit a message to the user to indicating that the device is already associated with a user profile and asking the user to log into the system.

An unregistered user (without a complete user profile) may send a connection request to server 105, and the personal area networking system 100 may create a temporary profile for the user and associate the connection with the temporary user profile. If the mobile device from which the connection request originated does not already have an associated user profile, authentication module 265 may generate a temporary user profile in user profile data store 280 associated with the user's mobile device and transmit to the user's mobile device a password and/or Universal Resource Locator (URL) for accessing a user interface that enables the user to complete the setup of the user's profile information (stage 320).

The user may then access server 105 using the temporary password and/or link generated by authentication module 265 and enter user profile information (stage 330). In an embodiment, the user may access server 105 using a browser included on the mobile device 101 or from a computer system 112. The user provides various contact information, such as email addresses, telephone numbers, and user IDs for various social networks. The user may also define various contact profiles, such as business contact, personal contact, family, or acquaintance, that are associated with various subsets of the user's contact information. The contact profiles indicate what information would be disclosed to a contact of a particular type by default, but the user may elect to expressly override these defaults to provide additional information to a particular contact, if desired.

User profile module 250 receives the user profile information from the user and updates the user profile information in user profile data store 280 (stage 340). Once the user profile has been set up, any pending connections stored in pending connections data store 295 may be completed and the user may begin sharing contact information.

FIG. 4 is a flow diagram of a process 400 for associating a mobile device with a user profile according an embodiment of the present invention. Server 105 receives a request to add a new mobile device to a user account (stage 410). In an embodiment, the request may be the form of a text message sent from the mobile device to a number associated with the personal area networking system. Authentication module 265 authenticates the user (stage 420) by determining whether the user exists in user profile data store 280. In an embodiment, the user sends an “add device” command to server 105 that includes the user ID and password of the user whose profile will should be updated to include the new device.

If authentication fails, server 105 may send a text message to the mobile device or other response indicating that the user profile could not be updated. Authentication may fail if an invalid user ID is provided (i.e., the user ID provided with the add device command doesn't match an existing user) or the password provided did not match the password associated with the user profile stored in user profile data store 280. If the user specified in the add device command does not have a user profile in user profile data store 280, server 105 may send a message to the user device inviting the user to create a new account.

If the user ID and password match that of a user profile in user profile data store 280, the user profile is updated to include the new device (stage 430) and the updated information is stored in user profile data store 280 (stage 440). Server 105 may optionally send a text message or email to the mobile device indicating that that device has been successfully added to the user's profile.

According to another embodiment, a connection request may also result in a mobile device being associated with a user profile. For example, a user with an existing user profile may be assigned a new telephone number or may receive a new mobile device. If the user has not followed process 400 described above to associate the device his or her user profile, the device may not yet be associated with the user's profile. However, server 105 will process the connection request and inform the user that he or she should log into the system and provide an access code that the user should enter into system 105 to associate the device with a user account.

According to another embodiment, a user may associate a portable electronic device, such as mobile device 101c, described above with a user profile. The user may connect a portable electronic device with a computer system 112, which connects to server 105 via network 110. The portable electronic device may then launch browser software on computer system 112 that accesses a device registration web page on server 105. The device registration web page may allow the user to associate the portable electronic device with an existing user profile or to create a new user profile and associate the new user profile with the portable electronic device. In one embodiment, the portable electronic device is connected to computer system 112 via a USB connection. In other embodiments, the portable electronic device may connect to via other types of wired and/or wireless connections.

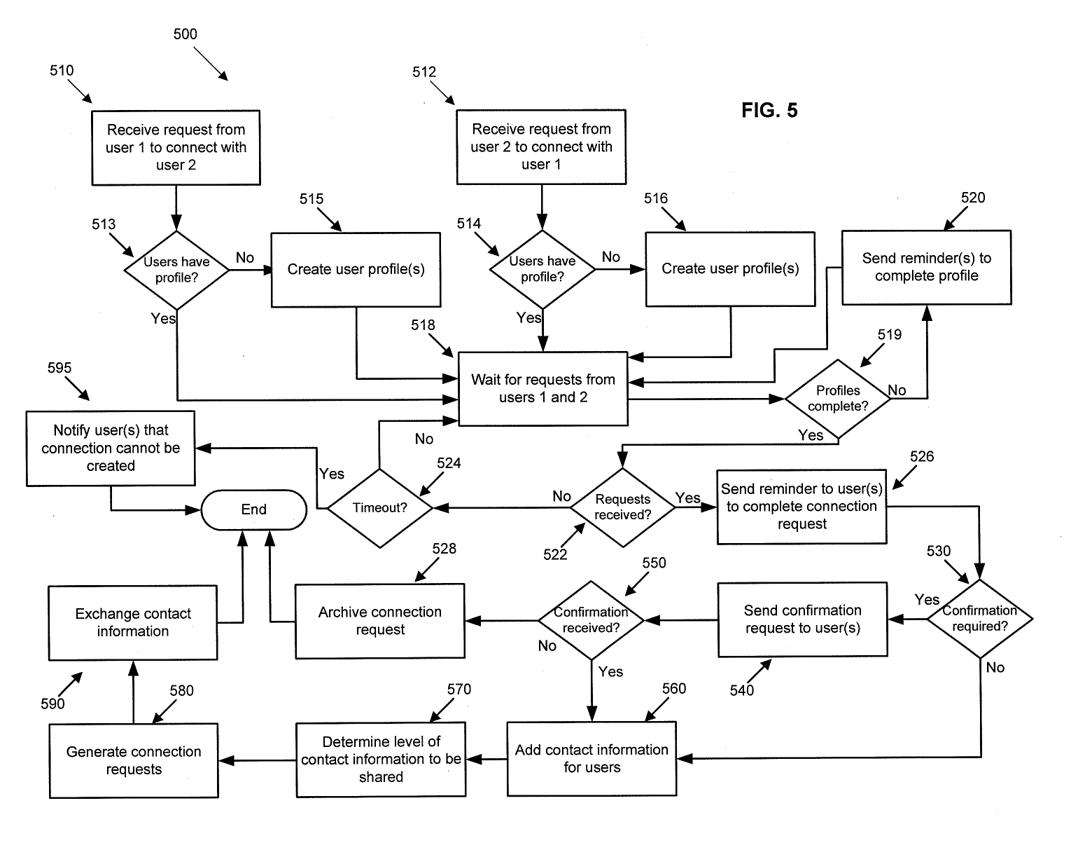

FIG. 5 is a flow diagram of a process 500 for exchanging contact information between users. In the embodiment illustrated in FIG. 5, two users, user 1 and user 2 exchange identification information and contact server 105 to establish connections with one another. Users 1 and 2 may verbally exchange identification information, may exchange physical copies of identification information, such as business cards that include a user identifier, may electronically exchange information, such as through a wired connection between devices, such as through a USB port connection, through a wireless connection between devices, such as a Bluetooth or other wireless connection, through email or text message, or via a tangible electronic medium such as a flash drive, a USB flash drive, or other computer readable medium. The identification information exchanged by users 1 and 2 may include a unique user IDs associated with the users on the personal area networking system or may include a telephone number or other unique identifier associated with a mobile device with the users.

Server 105 receives a request from user 1 to connect to user 2 (stage 510). Authentication module 265 determines whether user 1 and user 2 have a profile in user profile data store 280 (stage 513). If user 1 does not have a profile associated with the mobile device in the data store, a temporary user profile is created for user 1 and stored in user profile data store 280, and if user 2 does not have a profile, a temporary user profile is created for user 2 using the user ID provided by user 1 in the connection request (stage 515). Server 105 then waits for a connection request from user 2 to connect to user 1 to be received (stage 518). As described above, in an embodiment server 105 will not provide any contact information or social network information until both user 1 and user 2 submit a request to exchange contact information: user 1 submits a connection request that includes an identifier for user 2 and the user 2 submits a connection request that includes a user identifier for user 1. Server 105 holds the requests from both user 1 and user 2 until reciprocal requests are received from both users. Once the reciprocal requests are received, server 105 may execute the exchange of the users' contact information and/or social networking information.

According to some embodiments, a user may indicate in his or her user profile that server 105 may process connection requests as they are received by server 105 and without waiting for a reciprocal request to be received. In the event that a reciprocal request is not required by a user, the connection request may still be held in pending connections data store 295 pending further action. For example, if the user's profile is not complete, the connection request may be held until the user completes his or her user profile, or if the user has configured his or her profile to receive confirmation requests from server 105 before the connection request may be processed, the confirmation request may be placed in pending connections data store 295 until the confirmation request is processed. If a user indicates that his or her contact information may be shared with a new contact without receiving a reciprocal connection request, server 105 may provide the contact information and/or social networking information of the user to a new contact without receiving a reciprocal request from the new contact. But, the contact information and/or social networking information of the new contact may not automatically be provided to the user. For example, a user may submit a connection request to server 105 to establish connections with a new contact, and if the user does not require a reciprocal request to be received from the new contact, server 105 may provide the user's contact information and/or social networking information to the new contact. But, if the new contact requires that a reciprocal request be received before sharing his or her contact information, the new contact's contact information and/or social networking information will not be shared with the user unless a reciprocal request is submitted to server 105 by the new user. The new contact may also need to affirmatively respond to a confirmation request in addition to submitting a connection request to server 105. This spam prevention feature prevents users from being able to form connections with other users without the other users' permission.

Server 105 receives a request from user 2 to connect to user 1 (stage 512). The request from user 2 may be received before, after, or simultaneously as the request from user 1 (stage 510), because each user must submit the request to connect the other user to the management server from their mobile device 101, or in some embodiments, computer system 112. Authentication module 265 determines whether user 1 and user 2 have a profile in user profile data store 280 (stage 516). If user 2 does not have a profile associated with the mobile device in the data store, a temporary user profile is created for user 2 and stored in user profile data store 280, and if user 1 does not have a profile, a temporary profile is created for user 1 using the user ID provided by user 1 in the connection request (stage 516). Server 105 then waits for a connection request from user 1 to be received (stage 518). As described above, server 105 acts as an escrow service for the connection requests and will not provide any contact information or social network information until both user 1 and user 2 submit a request to exchange contact information.

A determination is made whether both users have completed their profiles (stage 519). If one or both users had a temporary user profile created for them, the connection requests from received from both of the users will be held in electronic escrow until the temporary user profiles are completed by the users. A reminder may optionally be sent to the user or users for whom a temporary user profile has been created (stage 520). For example, if user 1 submits a text message to the server that includes connection request to connect to user 2, and neither user 1 nor user 2 have a user profile, temporary user profiles are created for both users 1 and 2. The temporary user profile for user 1 may be tied to a telephone number of a mobile device from which user 1 submitted the connection request. A text message reminder may be sent to the telephone number associated with the mobile device of user 1 reminding the user to complete their user profile so that the connection request may be completed. User 2's temporary user profile may have been associated with an email address for user 2 that was included in the connection request from user 2. A reminder message may be generated and sent to user 2 at the email address associated with the temporary user profile.

A determination is made whether reciprocal connection requests have been received from both user 1 and user 2 (stage 522). According to an embodiment, the connection requests from user 1 and user 2 may include different identifiers associated with each of the users. For example, the user 1 may send a text message to server 205 that includes user 1's telephone number and user 2's telephone number to indicate that user 1 would like to connect with user 2. User 2 may send a text message to server 205 that includes the unique identifier or username for user 1 for the personal area networking system 100. Server 205 would recognize that the various identifiers sent by users 1 and 2 were associated with users 1 and 2 based on the user profile data associated with these users, even though the users did not include the same set of identifiers in the connection requests that they sent to server 205.

If a connection request has been received from one user but not the other, a determination is made whether a timeout period has elapsed (stage 524). A timeout period may be defined that places an upper limit on how long a connection request may remain pending while waiting for a reciprocal connection request to be received from another user. If the timeout period has elapsed, the user who submitted the pending connection request may be notified that the connection request could not be completed (stage 595) and the pending request is removed from pending connections data store 295. If the timeout period has not elapsed, then server 105 waits for the reciprocal request from the other user to be received (stage 518).

If connection requests have been received from both users, a reminder may be sent to one or both users to refresh their memories about the potential new contact (stage 526). For example, a reminder may include a text note generated by the user such as “Met CCK at conference, talked about partnering on new project, make business contact.” Reminders may also include global positioning system (GPS) coordinates or other location-based information sent by the mobile device that identifies the location where a connection request was made. Reminders may also include date and/or timestamp information that identifies a specific day and/or time that the connection request was made. Reminders may also include audiovisual media sent from the mobile device. For example, a user may take a photo or video clip of a potential new contact or may record a voice memo describing the meeting or event where the user met the potential new contact. In an embodiment, reminder information may also be displayed to the users on the contact interface provided by server 105.

Reminders to create an account may be sent to a user by the means that the initial connection request was made. For example, if a connection request was made via text message by a user that did not yet have a user profile created, the user may periodically be sent a text message, e.g., via SMS, reminding the user to complete his or her user profile. Server 105 may be configured to send reminders periodically, and server 105 may be configured to step sending reminders after a timeout period has elapsed.

According to another embodiment, reminders to confirm a connection or finalize other commands in the system may be presented to the user via a reminders web page provided by server 105 that provides a summary of the reminders associated with the user. The user may access details about the reminder, e.g., multimedia content such as images or other audiovisual content via the reminders web page. In some embodiments, server 105 may generate a reminder's summary that is sent to the user periodically via email if the user has an email address associated with his or her user profile.

A determination is made whether the one or both users wish to receive confirmations before establishing new connections (stage 530). A confirmation provides a user with the opportunity to accept or decline forming a connection with a new contact. If confirmations are not required, connections may automatically be formed by exchanging contact information and/or social network information between the users based on the type of contacts being formed and the user profile settings of each of the users.

If one or both users desire to confirm a connection request before establishing connections with a new contact, a confirmation is sent to the user or users that wish to receive the confirmation (stage 540). In an embodiment, a text message may be sent to the user's mobile device that indicates that a new connection is pending and provides the user with the opportunity to accept or decline the connection. In another embodiment, a user may alternatively access a web page through browser software on computer system 112, the web page providing an interface for viewing pending connection requests and for accepting or declining the connections. As described above, in some embodiments, a confirmation request may include reminder information such as text and/or other content that was submitted to server 105. The reminder information may include may include information about a potential new contact, notes about how and when the user met the new contact, audiovisual content, such as text, pictures, audio, video, or other media, GPS coordinates captured by the user's mobile device at the time that the connection request was sent to the server, and/or other information. The reminder information may be included in the confirmation request in order refresh the user's memory about a potential new contact before the user commits to exchanging contact information and/or social networking information with the potential new contact.

A determination is made whether confirmations accepting the new connections have been received from the users requesting the confirmations (stage 550). If a confirmation is required in order to complete a connection request, and the confirmation is not received before a confirmation timeout period elapses, the connection request may be archived in connections archive data store 297 and removed from pending connections data store 295 (stage 528). As described above, in some embodiments, connect requests that have been archived may be viewed by the user via an interface provided by server 105 and the user may also select an archived connection request to be executed. Connection requests may also be archived in connections archive data store 297 after processing confirmation requests. If a user confirms that he or she would like to form connections with a new contact associated with a pending connection request, the connection request is processed by server 105. Otherwise, if the user indicates that he or she would not like to form connections with the new contact associated with the pending connection request, the connection request may be moved from pending connections data store 295 to connections archive data store 297.

If no confirmations are required or the confirmations to create the new connections have been received, the users are added as contacts to one another based on the connection request information (stage 560). A determination is made which contact information is to be shared based on the type of contact that each user has designated in the connection request (stage 570). For example, user 1 and user 2 are two users that make connection requests to one another. User 1 is a member of LinkedIn®, Facebook®, and MySpace®, and user 1 has defined a “friends and family” contact profile level in which user 1's Facebook® and MySpace® profile information is shared with new contacts that are associated with this contact profile level and a “business” contact profile level in which user 1's LinkedIn® profile information is shared with new contacts. User 2 is also a member of LinkedIn®, Facebook®, and MySpace®, and user 2 has defined a “business” contact profile level in which user 1's Facebook®, MySpace®, and LinkedIn® profile information is shared with new contacts that are associated with user 2's business contact profile level. If both user 1 and user 2 request connections to each other using their respective “business” contact profile levels, a connection will automatically be established on LinkedIn® only even though user 1 and user 2 are both members of Facebook® and MySpace®, because user 1 only shares LinkedIn® profile information with business contacts. In an another embodiment, if user 1 also belongs to MSN Spaces® and has associated MSN Spaces® with the “business” contact profile level, user 2 will not automatically be connected to user 1 in MSN Spaces®, because user 2 is not a member of that social network. But, even though user 1 is not a member of MSN Spaces®, user 1 will still be notified that user 2 is a member of MSN Spaces® and will have the opportunity to later connect with user 2 on this social network. In an embodiment, user 1 would see on his or her contract interface an icon or other visual representation indicating that user 2 is a member of MSN Spaces® and has offered to automatically establish connections on that social network, but no connection has been established because user 1 is not a member of that social network. User 1 could later sign up for an account with MSN Spaces® and establish a connection with user 2 by clicking on or otherwise activating the icon representing MSN Spaces® on user 2's contact information.

In some embodiments, the contact information is to be shared with a new contact may be manually selected by the user rather than being determined based on a type of contact that each user has designated in the connection request. For example, in one embodiment, the user may designate a contact profile to be used when responding to a confirmation request. In some embodiments, server 105 may send a message to the user asking the user to select which information should be shared with the new contact. The personal area networking system 100 may provide a user interface, such as a web page, which the user can access by logging onto server 105 and select which information to be shared with the new contact. For example, the user may elect to share an email address and/or mobile number with a new contact, but may elect not to share social networking contact information with the new contact. According to another embodiment, the user may send a text message or email to server 105 identifies which information to share with the new contact. The message to server 105 may include a contact profile level, e.g. “business contact” that includes a predefined set of contact information to be shared with the new contact. In some embodiments, the user may also modify the details of contact information to be shared with the new contact as part of the predefined set of information associated with the contact profile level.

Social network connections requests may be generated to create connections between the users on social networking sites (stage 580), and any personal contact information, such as telephone numbers, and email or mailing address may be exchanged (stage 590). The personal contact information may be exchanged through a variety of electronic methods, such as text message or email. In an embodiment, the personal contact information may also be displayed on the contact interface provided by server 105 and when the users log in to the personal area networking system 100. The contact interface may also enable the user to manage the contact information, e.g., select additional information to share with contact or select information to no longer be shared with contact. For example, a user may associate a contact with a contact profile level that defines particular contact information and/or social networking information to share with the contact. The user may optionally modify the default level of information to be shared with the contact based on the contact level profile. The user may add additional contact information and/or social network information to be shared with the contact or may remove contact information and/or social network information to be shared with the contact. For example, the contact interface may include checkboxes that represent specific contact information and/or social network information, where a checked box indicates that the information associated with that checkbox is to be shared. If the user associates or has associated a contact with a particular contact profile level, the checkboxes may be populated with a set of default selections associated with that contact profile level. The user may override the default selections by checking or unchecking the checkboxes.

In an embodiment, a user may opt to no longer share contact information and/or social network information with a contact or may completely remove a contact from his or her contact list. The next time that the contact accesses his or her contact information from the contact interface, the contact (or ex-contact as the case may be if the user has completed removed the contact), will no longer be able to access the contact information that the user has opted to no longer share, or if the user has opted to completely remove the contact, the contact will no longer be able to access any of the user's contact information and/or social networking information from the personal area networking system 100.

In some embodiments, multi-user connection requests that allow a user to request connections with multiple contacts in a single connection request may also be created. For example, user 1 may send a request to connect to both users 2 and user 3. For example, user 1 may send a connection request to server 105 “Joe, Gina, met at baseball game, personal” to create connections with Joe and with Gina using the “personal” contact level profile. In an embodiment, server 105 may then parse the multi-person connection request and create separate connection requests for user 1 with Joe and user 1 with Gina, and process the connection requests in a fashion similar to process 600 described above. In other embodiments, server 105 may not create separate connection requests for user 1 with Joe and user 1 with Gina in response to receiving the multi-person connection request, and instead may process the connection request for each contact individually as if a separate connection request had been received from that contact. For example, if a reciprocal request is received from Gina but not from Joe, the processing to create connections with Gina may not be delayed while waiting for a reciprocal request from Joe.

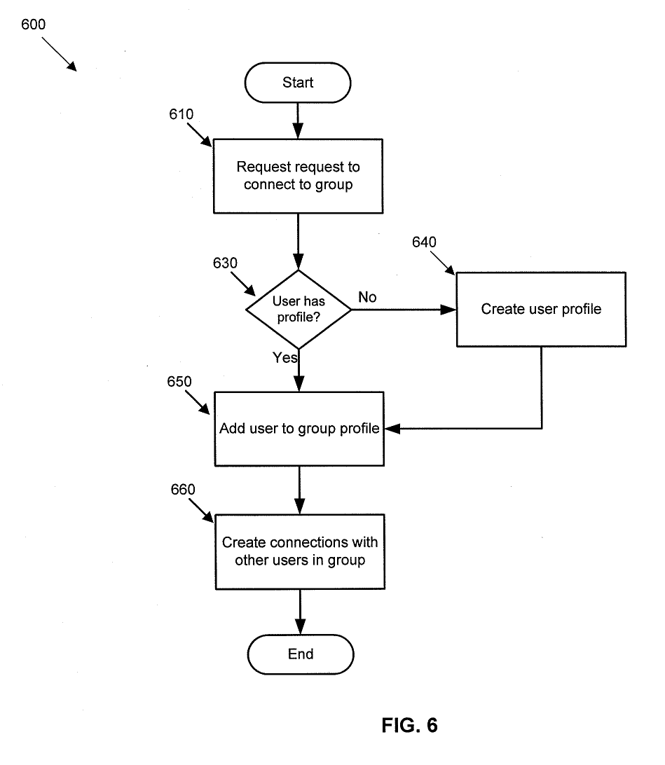

FIG. 6 is a flow diagram of a process 600 for connecting a user with a group. A user may wish to establish connections with a group of people. Groups enable a user to form connections with a multitude of people who are members of the group by submitting a connection request that includes a group identifier for the group, which results in connections being formed between the user and other users who have joined the group. For example, a user may wish to form connections with participants of a local sports league or may wish to form connections with members of a particular organization, such as a local Girl Scout group, or with members of the parent-teacher organization for the user's child's school. To connect to the group, the user may send a connection request to server 105 that includes a group identifier that identifies the group with whom the user would like to be connected (stage 610). In some embodiments, the user may also access a user interface, such as a web page, via server 105 via a computer 112 that enables the user to submit a group identifier of a group that the user would like to join. In some embodiments, a user may select a group or groups to join from a list of groups that the user may join. In some embodiments, a user's mobile device may automatically exchange codes with a group controlled device. In yet other embodiments, a group's identifier would come preloaded onto the user's device.

Authentication module 265 determines whether the user has a profile in user profile data store 280 (stage 630). If the user does not have a profile associated with the mobile device in the data store, a temporary user profile is created and stored in user profile data store 280 (stage 640). The user is then added to a group profile that indicates which users are members of the group. Group profiles may be stored in user profile data store 280 or may be stored in a separate group profile data store (stage 650). After adding the user to the group profile, SNP module 270 generates connection requests to the other group members for the user (stage 650). The connection requests might include direct exchange of contact information via email, text message, or other similar techniques. Connection requests may also be generated to each of the social networks. The specific contact information exchanged among group members may depend upon the group profile and/or the user profiles of each of the group members. For example, some members may exchange phone numbers and email addresses, while others opt to share only email addresses, while others opt to share their contact information on one or more social networking sites.

In an embodiment, the connection requests may be generated by authentication module 270 and stored in pending connections data store 295, and SNP module 270 accesses the pending connection requests from pending connections data store 295 and generates the appropriate connection requests to the social network providers 115.

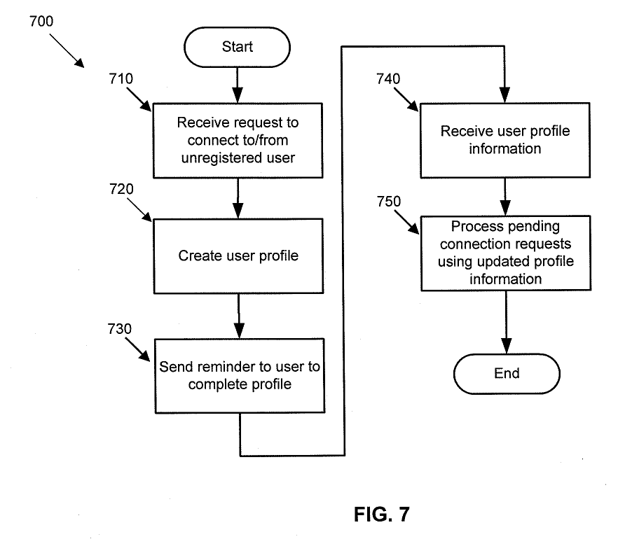

FIG. 7 is a flow diagram of a process 700 for processing pending connections. If a connection request is received where either the party requesting the connection to whom the user wishes to establish connections does not have a user profile in the personal area social networking system, the connection request may be stored in pending connection request data store 295 (stage 710). In an embodiment, pending connections may also be created when a user requests a confirmation before a new connection may be created.

A user profile is created for the user and/or the new contact (stage 720) if either the user or the new contact did not have a user profile identified by the authentication module 250. In an embodiment, a new user profile may be created for a user based and linked to the telephone number or other unique device identifier associated with the user's device from which the connection request originated.

A reminder is then sent to the user and/or the new contact (stage 730) to remind the user to complete their user profile. Connection requests associated with incomplete user profiles may be held until the user completes the user profile. User profile information is received from the user (stage 740), and pending connection requests associated with the user profile are processed using the user profile information provided (stage 750).

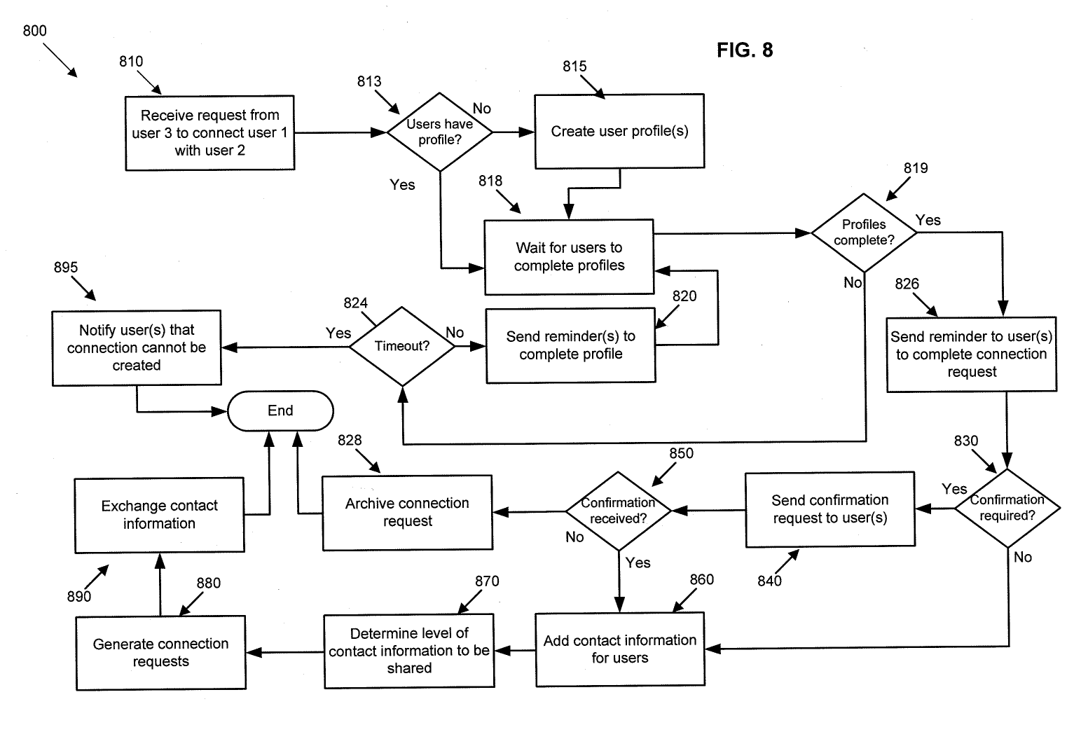

FIG. 8 is a flow diagram of a process 800 for exchanging contact information between users. In the embodiment illustrated in FIG. 8, a third party, e.g. user 3, requests that a connection be made for two other users, e.g. users 1 and 2. Third party connection requests may be used in a number of social and/or business situations. For example, user 1 may ask user 3 to connect her with user 2 who is a friend of user 3, because user 3 has a business that may be interested in services provided by a company managed by user 2. In another example, user 3 may be friends with both user 1 and user 2, who share similar interests, and user 3 may submit a request to connect users 1 and 2. In another embodiment, user 2 meets user 1 and wishes to form connections with user 1, but user 2 does not have his mobile phone or other portable electronic device with him, and instead asks user 3 to submit a third party connection request to server 105 on behalf of users 1 and 2. The identification information exchanged by users 1 and 2 may include unique user IDs associated with the users on the personal area networking system or may include telephone numbers or other unique identifiers associated with a mobile device with the users.

Server 105 receives a request from user 3 to connect to users 1 and 2 (stage 810). In some embodiments, server 105 may create two separate connection requests from the third party connection request: a connection request to connect user 1 to user 2 and a reciprocal request to connect user 2 to user 1. Authentication module 265 determines whether user 1 and user 2 have a profile in user profile data store 280 (stage 813). If user 1 does not have a profile associated with the mobile device in the data store, a temporary user profile is created for user 1 and stored in user profile data store 280, and if user 2 does not have a profile, a temporary user profile is created for user 2 using the user ID provided by user 1 in the connection request (stage 815).

If either user 1 or user 2 have not completed their profile, server 105 waits for users 1 and 2 to complete their users profiles (stage 818). Server 105 may hold the connection request until both users have completed their user profile. Once both users have completed their user profiles, server 105 may execute the exchange of the contact information and/or social networking information for users 1 and 2.

A determination is made whether both users have completed their profiles (stage 819). If one or both users had a temporary user profile created for them, the connection request may be held in electronic escrow until the temporary user profiles are completed by the users. A reminder may optionally be sent to the user or users for whom a temporary user profile has been created. For example, if neither user 1 nor user 2 have a user profile at the time that user 3 sends the third party connection request to server 105, temporary user profiles are created for both users 1 and 2. If user 3 used a telephone number or other contact information as the unique identifiers for users 1 and 2, server 105 may use this contact information to send a reminder to users 1 and 2 to complete their profile. For example, if user 3 submitted a telephone number associated with user 1's mobile device, server 105 may send a text message to user 1 at that telephone number reminding user 1 to complete their user profile. User 2's temporary user profile may have been associated with an email address for user 2 that was included in the connection request submitted by user 3. A reminder message may be generated and sent to user 2 at the email address associated with the temporary user profile.

If a connection request has been received from one user but not the other, a determination is made whether a timeout period has elapsed (stage 824). A timeout period may be defined that places an upper limit on how long a connection request may remain pending while waiting for a reciprocal connection request to be received from another user. If the timeout period has elapsed, the user, i.e., user 3, and/or the users who were to be connected, i.e. users 1 and 2, who submitted the pending third party connection request may be notified that the connection request could not be completed (stage 895) and the pending request is removed from pending connections data store 295. If the timeout period has not elapsed, then server 105 may send a reminder to user 1 and/or user 2 to complete their user profiles (stage 820).

If both users have complete user profiles, a reminder may be sent to one or both users to refresh their memories about the potential new contact or to include an introduction message or other message from the third party that has submitted the connection request (stage 826). For example, a reminder may include an introductory text note generated by the user such as “Bob—meet Jane, she has supplier information for construction contract.” Reminders may also include global positioning system (GPS) coordinates or other location-based information sent by the mobile device that identifies the location where a connection request was made. Reminders may also include date and/or timestamp information that identifies a specific day and/or time that the connection request was made. Reminders may also include audiovisual media sent from the mobile device. For example, the third party submitting the connection request may take a photo or video clip of a potential new contact or may record a voice memo introducing the parties to be connected. In an embodiment, reminder information may also be displayed to the users on the contact interface provided by server 105.

If both users 1 and 2 have completed their user profiles, a determination is made whether the one or both users wish to receive confirmations before establishing new connections (stage 830). A confirmation provides a user with the opportunity to accept or decline forming a connection with a new contact. If confirmations are not required, connections may automatically be formed by exchanging contact information and/or social network information between the users based on the type of contacts being formed and the user profile settings of each of the users. A user may have different confirmation requirements configured in his or her user profile for connection requests submitted by the user and connection requests submitted by third parties. For example, user may have configured her user profile to not require confirmations to be sent for connection requests submitted by user 1, but user 1 may request that a confirmation request be sent to her in response to third party connection requests to enable her to accept the connections or reject the connection request.

If one or both users desire to confirm a connection request before establishing connections with a new contact, a confirmation is sent to the user or users that wish to receive the confirmation (stage 840). In an embodiment, a text message may be sent to the user's mobile device that indicates that a new connection is pending and provides the user with the opportunity to accept or decline the connection. In another embodiment, a user may alternatively access a web page through browser software on computer system 112, the web page providing an interface for viewing pending connection requests and for accepting or declining the connections. As described above, in some embodiments, a confirmation request may include reminder information such as text and/or other content that was submitted to server 105.

A determination is made whether confirmations accepting the new connections have been received from the users requesting the confirmations (stage 850). If a confirmation is required in order to complete a connection request, and the confirmation is not received before a confirmation timeout period elapses, the connection request may be archived in connections archive data store 297 and removed from pending connections data store 295 (stage 828). As described above, in some embodiments, connection requests that have been archived may be viewed by the user via an interface provided by server 105 and the user may also select an archived connection request to be executed. Connection requests may also be archived in connections archive data store 297 after processing confirmation requests. If a user confirms that he or she would like to form connections with a new contact associated with a pending connection request, the connection request is processed by server 105. Otherwise, if the user indicates that he or she would not like to form connections with the new contact associated with the pending connection request, the connection request may be moved from pending connections data store 295 to connections archive data store 297.

If no confirmations are required or the confirmations to create the new connections have been received, the users are added as contacts to one another based on the connection request information (stage 860). A determination is made which contact information is to be shared based on the type of contact the third party requester designated in the connection request (stage 870). The determination as to which contact information is to shared is similar to that described in stage 570 of process 500 described above, except here the connection request has been submitted by a third party. The third party may include a connection profile level indicator with the connection request, such as “business contact” or “friends and family,” that identifies the type of connection that should be formed between users 1 and 2. If the third party connection request does not include a connection profile level indicator, user 1 and user 2 may be provided an opportunity to select which contact information and/or social network information should be shared. In an embodiment, the server 105 may generate a confirmation request that requests that the user confirm that the connects may be formed and to select which information should be shared.

As indicated above, in some embodiments, the contact information is to be shared with a new contact may be manually selected by the user rather than being determined based on a type of contact that each user has designated in the connection request. For example, in one embodiment, the user may designate a contact profile to be used when responding to a confirmation request. In some embodiments, server 105 may send a message to the user asking the user to select which information should be shared with the new contact. The personal area networking system 100 may provide a user interface, such as a web page, which the user can access by logging onto server 105 and select which information to be shared with the new contact. For example, the user may elect to share an email address and/or mobile number with a new contact, but may elect not to share social networking contact information with the new contact. According to another embodiment, the user may send a text message or email to server 105 identifies which information to share with the new contact. The message to server 105 may include a contact profile level, e.g. “business contact” that includes a predefined set of contact information to be shared with the new contact. In some embodiments, the user may also modify the details of contact information to be shared with the new contact as part of the predefined set of information associated with the contact profile level.

Social network connection requests may be generated to create connections between the users on social networking sites (stage 880), and any personal contact information, such as telephone numbers, and email or mailing address may be exchanged (stage 890). The personal contact information may be exchanged through a variety of electronic methods, such as text message or email. In an embodiment, the personal contact information may also be displayed on the contact interface provided by server 105 and when the users log in to the personal area networking system 100. The contact interface may also enable the user to manage the contact information, e.g., select additional information to share with contact or select information to no longer be shared with contact. For example, a user may associate a contact with a contact profile level that defines particular contact information and/or social networking information to share with the contact. The user may optionally modify the default level of information to be shared with the contact based on the contact level profile. The user may add additional contact information and/or social network information to be shared with the contact or may remove contact information and/or social network information to be shared with the contact. For example, the contact interface may include checkboxes that represent specific contact information and/or social network information, where a checked box indicates that the information associated with that checkbox is to be shared. If the user associates or has associated a contact with a particular contact profile level, the checkboxes may be populated with a set of default selections associated with that contact profile level. The user may override the default selections by checking or unchecking the checkboxes.

In some embodiments, multi-user third-party connection requests that allow a user to request connections for multiple contacts in a single connection request may also be created. For example, user 1 may send a request to connect users 2, user 3, and user 4. For example, user 1 may send a connection request to server 105 “Joe to Gina to Bob, you should meet to talk about baseball” to create connections between with Joe and Gina, Joe and Bob, and Gina and Bob. The message text “you should meet to talk about baseball” may be sent to Joe, Gina, and Bob as a reminder. In an embodiment, server 105 may then parse the multi-person connection request and create separate third-party connection requests, and may then process the connection requests in a fashion similar to process 800 described above. In other embodiments, server 105 may not create separate third-party connection requests in response to receiving the multi-person third party connection request, and instead may process the third party connection request for each combination of contacts as if a separate connection request had been received.

In another embodiment, a user may include his or her password in a third-party connection request in order to have server 105 process the connection request as if it originated from the PIN providing user. For example, user 1 may wish to connect with user 2, but user 1 has forgotten to bring her mobile phone. User 1 asks user 3 to borrow his mobile phone to submit a connection request and user 1 includes her password in the connection request. Server 105 receives the connection request and recognizes that user 1 has provided her password and processes the connection request as if the connection request originated from a device associated with user 1's profile. Server 105 may then process the connection request in a fashion similar to process 800 described above.

Other embodiments are within the scope of the disclosure and the claims.

What is claimed is:

1. A method for managing the electronic exchange of contact information between users, the method comprising:
receiving a first connection request at a management server from a first user, the connection request including a first identifier associated with the first user and a second identifier associated with a second user with whom the first user would like to exchange contact information;
holding the first connection request in an electronic escrow wherein no connections are formed between the first user and the second user while the first connect request is held in the electronic escrow;
determining whether a second connection request from the second user has been received at the management server, the second connection request indicating that the second user would like to exchange contact information with the first user, the connection request including a third identifier associated with the first user and a fourth identifier associated with the second user; and
executing the first connection request and the second connection request in response to determining that the second connection request has been received at the management server, wherein executing the first connection request includes providing contact information for the first user to the second user, and wherein executing the second connection request further comprises providing contact information for the second user to the first user.

2. The method of claim 1 wherein the first and third identifiers are the same identifier.

3. The method of claim 1 wherein the second and fourth identifiers are the same identifier.

4. The method of claim 1 further comprising:
determining whether a timeout period has elapsed prior to receiving the second connection request; and
if the timeout period has elapsed prior to receiving the second connection request, removing the first connection request from the electronic escrow without executing the first connection request so that no contact information for the first user is provided to the second user.

5. The method of claim 1 further comprising:
in response to receiving the first connection request, determining whether the first user and the second user have a user profile; and
creating a temporary user profile for the first user if the first user does not have a user profile;
creating a temporary user profile for the second user if the second user does not have a user profile;
wherein if a temporary user profile is created for at least one of the first user and the second user, the first connection request is held in the electronic escrow until user profile information is received by the server for at the least one of the first user and the second user for whom a temporary user profile was created.

6. The method of claim 5 wherein if a temporary user profile is created for at least one of the first user and the second user, the second connection request is held in the electronic escrow after being received until user profile information is received by the server for at the least one of the first user and the second user for whom a temporary user profile was created.

7. The method of claim 6 wherein a reminder to provide user profile information to the server is transmitted to the at least one of the first user and the second user for whom a temporary user profile is created.

8. The method of claim 1 further comprising:
sending a confirmation request to at least one of the first user and the second user requesting conformation that the first and second connection requests may be executed; and
receiving a response to the confirmation request from the at least one of the first user and the second user in response;
executing the first connection request and the second connection request if the response confirms that the first and second connection requests may be executed; and
removing the first connection request from the electronic escrow without executing the first connection request if the response does not confirm that the first and second connection requests may be executed.

9. The method of claim 8 further comprising:
removing the first connection request and the second connection request from the electronic escrow without executing the first connection request and the second connection request if the response to the confirmation request is not received before a timeout period elapses.

10. The method of claim 8 wherein the confirmation request includes reminder information.

11. The method of claim 10 wherein the reminder information includes descriptive information about a new contact with whom connections would be created if a response to the confirmation request indicates that the connections may be created.

12. The method of claim 10 wherein the reminder information includes descriptive information about an event with a new contact with whom connection would be created.

13. The method of claim 10 further comprising:
selecting an electronic advertisement based on the reminder information; and
sending the electronic advertisement to the to at least one of the first user and the second.

14. The method of claim 9 further comprising:
archiving the first connection request after removing the first connection request from the electronic escrow.

15. The method of claim 8 wherein the response to the confirmation request includes a contact profile level to associate with connections to be formed between the first and second users.

16. The method of claim 1 wherein contact information exchanged in response to executing the first connection request and the second connection request is determined based on the user profile information of the first and second users.

17. The method of claim 16 wherein contact information exchanged is further determined based on a contact level associated with the first and second connection requests.

18. The method of claim 1 wherein the first user receives electronically at a mobile device of the first user the unique identifier of the second user from a mobile device of the second user.

19. The method of claim 18 wherein the mobile device of the first user wirelessly receives the unique identifier of the second user.

20. The method of claim 19 wherein the mobile device of the first user automatically receives the unique identifier of the second user when the mobile device of the second user is located proximate to the mobile device of the first user.

21. The method of claim 19 wherein the mobile device of the second user transmits the unique identifier of the second user when a button is depressed on the mobile device of the second user.

22. The method of claim 18 wherein the mobile device of the second user is configured to generate the unique identifier of the second user.

23. The method of claim 1 further comprising:
determining whether a user profile of the first user indicates that the first user does not require a reciprocal connection request to be received in order to execute a connection request;
executing the first connection request to provide contact information for the first user to the second user without holding the first connection request in electronic escrow until a reciprocal connection request is received from the second user, if the user profile of the first user indicates that the first user does not require a reciprocal connection request to be received in order to execute a connection request.

24. The method of claim 23 wherein if the user profile of the second user indicates that the second user requires a reciprocal connection request to be received in order to execute a connection request, the contact information of the second user is not provided to the first user until the second connection request is received from the second user.

25. The method of claim 1 further comprising:
determining whether a user profile of the second user indicates that the second user does not require a reciprocal connection request to be received in order to execute a connection request;
executing the first connection request to provide contact information for the first user to the second user without holding the first connection request in electronic escrow until a reciprocal connection request is received from the second user, if the user profile of the second user indicates that the second user does not require a reciprocal connection request to be received in order to execute a connection request.

26. The method of claim 1 further comprising:
receiving reminder message content from the first user, the reminder message content including information about the second user; and
sending the reminder message to the first user after a predetermined period of time to remind the first user to confirm the connection request with the second user.

27. The method of claim 26 further comprising:
sending the reminder message to the second user after the predetermined period of time to remind the second user to confirm the connection request with the first user.

28. The method of claim 1 further comprising:
receiving reminder message content from the first user, the reminder message content including information about the second user; and
displaying the reminder message to the first user on a contact interface.

29. The method of claim 1 further comprising:
receiving user profile information from the first user, the user profile information including at least one contact profile level, the contact profile level defining a set of contact information to be provided to contact associated with the contact profile level.

30. The method of claim 29 further comprising:
receiving update information for a first contact profile level associated with the user profile of the first user; and
removing contact information from the set of contact profile information identified in the update to be removed from the set of contact profile information; and
adding contact information to the set of contact profile information identified in the update to be added the set of contact profile information;
wherein the updated set of contact profile information is provided to all contacts associated with the first contact profile level.

31. The method of claim 29 further comprising:
receiving from the first user an update shared information command to update a set of contact information shared with the second user;
updating the contact information shared with the second user based on the updated shared information command.

32. The method of claim 1 wherein the first connection request includes a direct connection command, the direct connection command identifying a social network on which the first user wishes to establish a connection with the second user.

33. The method of claim 1 further comprising:
receiving an add device command at the server to add a device to a user profile;
determining whether the add device command includes a user identifier and an access code associated with a user profile;
associating the device with the user profile if the access code provided with the add device command matches an access code associated with the user profile.

34. The method of claim 1 further comprising:
receiving an add device command at the server from the first user to add a device to a user profile associated with the user profile;
generating a unique code for the device;
sending the unique code to the first user;
receiving login information for the first user;
validating the login information;
receiving the unique code from the user;
associating the device with a user profile of the first user.

35. The method of claim 1 further comprising:
receiving a group connection request from the first user identifying a group of users with whom the first user would like to exchange contact information; and
exchanging contact information between the first user and each of the members of the group of users identified in the group connection request.

36. The method of claim 1 wherein the first connection request includes a third identifier associated with a third user with whom the first user would like to exchange contact information.

37. A computer program product embedded in a computer-readable medium and including instructions that, when executed by at least one computing device, cause the at least one computing device to:
receive a first connection request at a management server from a first user, the connection request including a first identifier associated with the first user and a second identifier associated with a second user with whom the first user would like to exchange contact information;
hold the first connection request in an electronic escrow wherein no connections are formed between the first user and the second user while the first connect request is held in the electronic escrow;
determine whether a second connection request from the second user has been received at the management server, the second connection request indicating that the second user would like to exchange contact information with the first user, the connection request including a third identifier associated with the first user and a fourth identifier associated with the second user; and
execute the first connection request and the second connection request in response to determining that the second connection request has been received at the management server, wherein executing the first connection request includes providing contact information for the first user to the second user, and wherein executing the second connection request further comprises providing contact information for the second user to the first user.

38. The computer program product of claim 37 wherein the first and third identifiers are the same identifier.

39. The computer program product of claim 37 wherein the second and fourth identifiers are the same identifier.

40. The computer program product of claim 37 further comprising instructions that, when executed by the at least one computing device, cause the at least one computing device to:
determine whether a timeout period has elapsed prior to receiving the second connection request; and
if the timeout period has elapsed prior to receiving the second connection request, remove the first connection request from the electronic escrow without executing the first connection request so that no contact information for the first user is provided to the second user.

41. The computer program product of claim 37 further comprising instructions that, when executed by the at least one computing device, cause the at least one computing device to:
in response to receiving the first connection request, determine whether the first user and the second user have a user profile; and
create a temporary user profile for the first user if the first user does not have a user profile;
create a temporary user profile for the second user if the second user does not have a user profile;
wherein if a temporary user profile is created for at least one of the first user and the second user, the first connection request is held in the electronic escrow until user profile information is received by the server for at the least one of the first user and the second user for whom a temporary user profile was created.

42. The computer program product of claim 41 wherein if a temporary user profile is created for at least one of the first user and the second user, the second connection request is held in the electronic escrow after being received until user profile information is received by the server for at the least one of the first user and the second user for whom a temporary user profile was created.

43. The computer program product of claim 41 wherein a reminder to provide user profile information to the server is transmitted to the at least one of the first user and the second user for whom a temporary user profile is created.

44. The computer program product of claim 37 further comprising instructions that, when executed by the at least one computing device, cause the at least one computing device to:
send a confirmation request to at least one of the first user and the second user requesting conformation that the first and second connection requests may be executed; and
receive a response to the confirmation request from the at least one of the first user and the second user in response;
execute the first connection request and the second connection request if the response confirms that the first and second connection requests may be executed; and
remove the first connection request from the electronic escrow without executing the first connection request if the response does not confirm that the first and second connection requests may be executed.

45. The computer program product of claim 44 further comprising instructions that, when executed by at least one computing device, cause the at least one computing device to:
remove the first connection request and the second connection request from the electronic escrow without executing the first connection request and the second connection request if the response to the confirmation request is not received before a timeout period elapses.

46. The computer program product of claim 45 wherein the confirmation request includes reminder information.

47. The computer program product of claim 46 wherein the reminder information includes descriptive information about a new contact with whom connections would be created if a response to the confirmation request indicates that the connections may be created.

48. The computer program product of claim 46 wherein the reminder information includes descriptive information about an event with a new contact with whom connection would be created.

49. The computer program product of claim 46 further comprising instructions that, when executed by the at least one computing device, cause the at least one computing device to:
select an electronic advertisement based on the reminder information; and
send the electronic advertisement to the to at least one of the first user and the second user.

50. The computer program product of claim 46 further comprising instructions that, when executed by the at least one computing device, cause the at least one computing device to:
archive the first connection request after removing the first connection request from the electronic escrow.

51. The computer program product of claim 44 wherein the response to the confirmation request includes a contact profile level to associate with connections to be formed between the first and second users.

52. The computer program product of claim 37 wherein contact information exchanged in response to executing the first connection request and the second connection request is determined based on the user profile information of the first and second users.

53. The computer program product of claim 52 wherein contact information exchanged is further determined based on a contact level associated with the first and second connection requests.

54. The computer program product of claim 37 wherein the first user receives electronically at a mobile device of the first user the unique identifier of the second user from a mobile device of the second user.

55. The computer program product of claim 54 wherein the mobile device of the first user wirelessly receives the unique identifier of the second user.

56. The computer program product of claim 55 wherein the mobile device of the first user automatically receives the first user the unique identifier of the second user when the mobile device of the second user is located proximate to the mobile device of the first user.

57. The computer program product of claim 55 wherein the mobile device of the second user transmits the unique identifier of the second user when a button is depressed on the mobile device of the second user.

58. The computer program product of claim 54 wherein the mobile device of the second user is configured to generate the unique identifier of the second user.

59. The computer program product of claim 37 further comprising instructions that, when executed by the at least one computing device, cause the at least one computing device to:
determine whether a user profile of the first user indicates that the first user does not require a reciprocal connection request to be received in order to execute a connection request;
execute the first connection request to provide contact information for the first user to the second user without holding the first connection request in electronic escrow until a reciprocal connection request is received from the second user, if the user profile of the first user indicates that the first user does not require a reciprocal connection request to be received in order to execute a connection request.

60. The computer program product of claim 59 wherein if the user profile of the second user indicates that the second user requires a reciprocal connection request to be received in order to execute a connection request, the contact information of the second user is not provided to the first user until the second connection request is received from the second user.

61. The computer program product of claim 37 further comprising instructions that, when executed by the at least one computing device, cause the at least one computing device to:
determine whether a user profile of the second user indicates that the second user does not require a reciprocal connection request to be received in order to execute a connection request;
execute the first connection request to provide contact information for the first user to the second user without holding the first connection request in electronic escrow until a reciprocal connection request is received from the second user, if the user profile of the second user indicates that the second user does not require a reciprocal connection request to be received in order to execute a connection request.

62. The computer program product of claim 37 further comprising instructions that, when executed by the at least one computing device, cause the at least one computing device to:
receive reminder message content from the first user, the reminder message content including information about the second user; and
send the reminder message to the first user after a predetermined period of time to remind the first user to confirm the connection request with the second user.

63. The computer program product of claim 62 further comprising instructions that, when executed by the at least one computing device, cause the at least one computing device to:
send the reminder message to the second user after the predetermined period of time to remind the second user to confirm the connection request with the first user.

64. The computer program product of claim 37 further comprising instructions that, when executed by the at least one computing device, cause the at least one computing device to:
receive reminder message content from the first user, the reminder message content including information about the second user; and
display the reminder message to the first user on a contact interface.

65. The computer program product of claim 37 further comprising instructions that, when executed by the at least one computing device, cause the at least one computing device to:
receive user profile information from the first user, the user profile information including at least one contact profile level, the contact profile level defining a set of contact information to be provided to contact associated with the contact profile level.

66. The computer program product of claim 65 further comprising instructions that, when executed by the at least one computing device, cause the at least one computing device to:
receive update information for a first contact profile level associated with the user profile of the first user; and
remove contact information from the set of contact profile information identified in the update to be removed from the set of contact profile information; and
add contact information to the set of contact profile information identified in the update to be added the set of contact profile information;
wherein the updated set of contact profile information is provided to all contacts associated with the first contact profile level.

67. The computer program product of claim 65 further comprising instructions that, when executed by the at least one computing device, cause the at least one computing device to:
receive from the first user an update shared information command to update a set of contact information shared with the second user;
update the contact information shared with the second user based on the updated shared information command.

68. The computer program product of claim 37 wherein the first connection request includes a direct connection command, the direct connection command identifying a social network on which the first user wishes to establish a connection with the second user.

69. The computer program product of claim 37 further comprising instructions that, when executed by the at least one computing device, cause the at least one computing device to:
receive an add device command at the server to add a device to a user profile;
determine whether the add device command includes a user identifier and an access code associated with a user profile;
associate the device with the user profile if the access code provided with the add device command matches an access code associated with the user profile.

70. The computer program product of claim 37 further comprising instructions that, when executed by the at least one computing device, cause the at least one computing device to:
receive an add device command at the server from the first user to add a device to a user profile associated with the user profile;
generate a unique code for the device;
send the unique code to the first user;
receive login information for the first user;
validate the login information;
receive the unique code from the user;
associate the device with a user profile of the first user.

71. The computer program product of claim 37 further comprising instructions that, when executed by the at least one computing device, cause the at least one computing device to:
receiving a group connection request from the first user identifying a group of users with whom the first user would like to exchange contact information; and
exchanging contact information between the first user and each of the members of the group of users identified in the group connection request.

72. The computer program product of claim 37 wherein the first connection request includes a third identifier associated with a third user with whom the first user would like to exchange contact information.

73. A system for managing the electronic exchange of contact information between users, the system comprising:
a processor; and
a memory device including instructions that, when executed by the processor, cause the processor to:
receive a first connection request at a management server from a first user, the connection request including a first identifier associated with the first user and a second identifier associated with a second user with whom the first user would like to exchange contact information;
hold the first connection request in an electronic escrow wherein no connections are formed between the first user and the second user while the first connect request is held in the electronic escrow;
determine whether a second connection request from the second user has been received at the management server, the second connection request indicating that the second user would like to exchange contact information with the first user, the connection request including a third identifier associated with the first user and a fourth identifier associated with the second user; and
execute the first connection request and the second connection request in response to determining that the second connection request has been received at the management server, wherein executing the first connection request includes providing contact information for the first user to the second user, and wherein executing the second connection request further comprises providing contact information for the second user to the first user.

74. The system of claim 73 wherein the first and third identifiers are the same identifier.

75. The system of claim 73 wherein the second and fourth identifiers are the same identifier.

76. The system of claim 73 further comprising instructions that, when executed by the processor, cause the processor to:
determine whether a timeout period has elapsed prior to receiving the second connection request; and
if the timeout period has elapsed prior to receiving the second connection request, remove the first connection request from the electronic escrow without executing the first connection request so that no contact information for the first user is provided to the second user.

77. The system of claim 73 further comprising instructions that, when executed by the processor, cause the processor to:
in response to receiving the first connection request, determine whether the first user and the second user have a user profile; and
create a temporary user profile for the first user if the first user does not have a user profile;
create a temporary user profile for the second user if the second user does not have a user profile;
wherein if a temporary user profile is created for at least one of the first user and the second user, the first connection request is held in the electronic escrow until user profile information is received by the server for at the least one of the first user and the second user for whom a temporary user profile was created.

78. The system of claim 77 wherein if a temporary user profile is created for at least one of the first user and the second user, the second connection request is held in the electronic escrow after being received until user profile information is received by the server for at the least one of the first user and the second user for whom a temporary user profile was created.

79. The system of claim 78 wherein a reminder to provide user profile information to the server is transmitted to the at least one of the first user and the second user for whom a temporary user profile is created.

80. The system of claim 73 further comprising instructions that, when executed by the processor, cause the processor to:
send a confirmation request to at least one of the first user and the second user requesting conformation that the first and second connection requests may be executed; and
receive a response to the confirmation request from the at least one of the first user and the second user;
execute the first connection request and the second connection request if the response confirms that the first and second connection requests may be executed; and
remove the first connection request from the electronic escrow without executing the first connection request if the response does not confirm that the first and second connection requests may be executed.

81. The system of claim 80 further comprising instructions that, when executed by the processor, cause the processor to:
remove the first connection request and the second connection request from the electronic escrow without executing the first connection request and the second connection request if the response to the confirmation request is not received before a timeout period elapses.

82. The system of claim 81 wherein the confirmation request includes reminder information.

83. The system of claim 82 wherein the reminder information includes descriptive information about a new contact with whom connections would be created if a response to the confirmation request indicates that the connections may be created.

84. The system of claim 82 wherein the reminder information includes descriptive information about a new contact with whom connections would be created if a response to the confirmation request indicates that the connections may be created.

85. The system of claim 82 further comprising instructions that, when executed by the processor, cause the processor to:
select an electronic advertisement based on the reminder information; and
send the electronic advertisement to the to at least one of the first user and the second user.

86. The system of claim 82 further comprising instructions that, when executed by the processor, cause the processor to:
archive the first connection request after removing the first connection request from the electronic escrow.

87. The system of claim 80 wherein the response to the confirmation request includes a contact profile level to associate with connections to be formed between the first and second users.

88. The system of claim 73 wherein contact information exchanged in response to executing the first connection request and the second connection request is determined based on the user profile information of the first and second users.

89. The system of claim 89 wherein contact information exchanged is further determined based on a contact level associated with the first and second connection requests.

90. The system of claim 73 wherein the first user receives electronically at a mobile device of the first user the unique identifier of the second user from a mobile device of the second user.

91. The system of claim 90 wherein the mobile device of the first user wirelessly receives the unique identifier of the second user.

92. The system of claim 91 wherein the mobile device of the first user automatically receives the first user the unique identifier of the second user when the mobile device of the second user is located proximate to the mobile device of the first user.

93. The system of claim 91 wherein the mobile device of the second user transmits the unique identifier of the second user when a button is depressed on the mobile device of the second user.

94. The system of claim 90 wherein the mobile device of the second user is configured to generate the unique identifier of the second user.

95. The system of claim 73 further comprising instructions that, when executed by the processor, cause the processor to:
determine whether a user profile of the first user indicates that the first user does not require a reciprocal connection request to be received in order to execute a connection request;
execute the first connection request to provide contact information for the first user to the second user without holding the first connection request in electronic escrow until a reciprocal connection request is received from the second user, if the user profile of the first user indicates that the first user does not require a reciprocal connection request to be received in order to execute a connection request.

96. The system of claim 95 wherein if the user profile of the second user indicates that the second user requires a reciprocal connection request to be received in order to execute a connection request, the contact information of the second user is not provided to the first user until the second connection request is received from the second user.

97. The method of claim 73 further comprising instructions that, when executed by the processor, cause the processor to:
determine whether a user profile of the second user indicates that the second user does not require a reciprocal connection request to be received in order to execute a connection request;
execute the first connection request to provide contact information for the first user to the second user without holding the first connection request in electronic escrow until a reciprocal connection request is received from the second user, if the user profile of the second user indicates that the second user does not require a reciprocal connection request to be received in order to execute a connection request.

98. The system of claim 73 further comprising instructions that, when executed by the processor, cause the processor to:
receive reminder message content from the first user, the reminder message content including information about the second user; and
send the reminder message to the first user after a predetermined period of time to remind the first user to confirm the connection request with the second user.

99. The system of claim 98 further comprising:
sending the reminder message to the second user after the predetermined period of time to remind the second user to confirm the connection request with the first user.

100. The system of claim 73 further comprising instructions that, when executed by the processor, cause the processor to:
receive reminder message content from the first user, the reminder message content including information about the second user; and
display the reminder message to the first user on a contact interface.

101. The system of claim 73 further comprising instructions that, when executed by the processor, cause the processor to:
receive user profile information from the first user, the user profile information including at least one contact profile level, the contact profile level defining a set of contact information to be provided to contact associated with the contact profile level.

102. The system of claim 101 further comprising instructions that, when executed by the processor, cause the processor to:
receive update information for a first contact profile level associated with the user profile of the first user; and
remove contact information from the set of contact profile information identified in the update to be removed from the set of contact profile information; and
add contact information to the set of contact profile information identified in the update to be added the set of contact profile information;
wherein the updated set of contact profile information is provided to all contacts associated with the first contact profile level.

103. The system of claim 101 further comprising instructions that, when executed by the processor, cause the processor to:
receive from the first user an update shared information command to update a set of contact information shared with the second user;
update the contact information shared with the second user based on the updated shared information command.

104. The system of claim 73 wherein the first connection request includes a direct connection command, the direct connection command identifying a social network on which the first user wishes to establish a connection with the second user.

105. The system of claim 73 further comprising instructions that, when executed by the processor, cause the processor to:
receive an add device command at the server to add a device to a user profile;
determine whether the add device command includes a user identifier and an access code associated with a user profile;
associate the device with the user profile if the access code provided with the add device command matches an access code associated with the user profile.

106. The system of claim 73 further comprising instructions that, when executed by the processor, cause the processor to:
receive an add device command at the server from the first user to add a device to a user profile associated with the user profile;
generate a unique code for the device;
send the unique code to the first user;
receive login information for the first user;
validate the login information;
receive the unique code from the user;
associate the device with a user profile of the first user.

107. The system of claim 73 further comprising instructions that, when executed by the processor, cause the processor to:
receiving a group connection request from the first user identifying a group of users with whom the first user would like to exchange contact information; and
exchanging contact information between the first user and each of the members of the group of users identified in the group connection request.

108. The method of claim 73 wherein the first connection request includes a third identifier associated with a third user with whom the first user would like to exchange contact information.

109. A method for managing the electronic exchange of contact information between users, the method comprising:
receiving a third party connection request at a management server to exchange contact information between a first user and a second user, the connection request including a first identifier associated with the first user and a second identifier associated with the second user, the connection request being received from a third user;
holding the third party connection request in an electronic escrow, wherein no connections are formed between the first user and the second user while the first connect request is held in the electronic escrow;
sending a first confirmation request to the first user to confirm that the third party connection request may be executed;
sending a second confirmation request to the second user to confirm that the third party connection request may be executed;
determining that a first response to the first confirmation request and a second response to the second confirmation request has been received at the management server; and
executing the third party connection request in response to determining that the first and second responses have been received, wherein executing the third party connection request includes providing contact information for the first user to the second user and providing contact information for the second user to the first user.

110. The method of claim 109 further comprising:
removing the third party connection request from the electronic escrow without executing the third party connection request if the first and second responses are not received before a timeout period elapses.

111. The method of claim 109 further comprising:
in response to receiving the third party connection request, determining whether the first user and the second user have a user profile; and
creating a temporary user profile for the first user if the first user does not have a user profile;
creating a temporary user profile for the second user if the second user does not have a user profile;
wherein if a temporary user profile is created for at least one of the first user and the second user, the third party connection request is held in the electronic escrow until user profile information is received by the server for at the least one of the first user and the second user for whom a temporary user profile was created.

112. The method of claim 111 wherein if a temporary user profile is created for at least one of the first user and the second user, the third party connection request is held in the electronic escrow after being received until user profile information is received by the server for at the least one of the first user and the second user for whom a temporary user profile was created.

113. The method of claim 112 further comprising:
sending a reminder to provide user profile information to the server is transmitted to the at least one of the first user and the second user for whom a temporary user profile is created.

114. The method of claim 112 further comprising:
sending introduction information to the at least one of the first user and the second user, the introduction information being provided by the third user.

115. The method of claim 109 wherein the third party connection request includes a third identifier associated with a third user with whom contact information is to be exchanged with the first user and the second user.
